(19) United States
(12) Patent Application Publication
(10) Pub. No.: US 2020/0141618 A1
(43) Pub. Date: May 7, 2020

(54) FLUID STIRRING AND LIQUEFACTION PROMOTING APPARATUS DISPOSED ON PIPELINE OF HEAT PUMP SYSTEM

(71) Applicant: Hajime ODANI, Toyko (JP)

(72) Inventors: HAJIME ODANI, TOKYO (JP); GI WAN SEO, YONGIN-SI (KR); HYO SEONG KIM, SEOUL (KR)

(21) Appl. No.: 16/495,971

(22) PCT Filed: May 29, 2017
(86) PCT No.: PCT/KR2017/005561

§ 371 Date: Sep. 20, 2019

(30) Foreign Application Priority Data
Mar. 20, 2017 (KR) 10-2017-0034592

(51) Int. Cl. F25B 31/00; F25B 41/00; B01F 7/10; B01F 7/00

(52) U.S. Cl. CPC F25B 31/004; F25B 41/003; F25B 2500/16; B01F 7/00458; F25B 2500/06; B01F 7/10

(57) ABSTRACT

It is an object of the present invention to provide a fluid stirring and liquefaction promoting apparatus which enables uniform mixture of refrigerator oil with refrigerant, thereby improving the heat exchange efficiency of heat pump systems and reducing the energy consumption. There is provided a liquefaction promoting apparatus to be disposed on a pipeline of a heat pump system for the purpose of stirring and uniformly mixing the fluid containing refrigerant and refrigerator oil circulating therein. The apparatus comprises a cylindrical casing, an one or more channelizing units each composed of a pair of large-diameter disks on its outer side and a pair of small-diameter disks on its inner side disposed in axial alignment inside the cylindrical casing. Each of the large-diameter disks is on its inner surface with a honeycomb panel having polygonal cells and each of the small-diameter disks is formed on its outer surface with a honeycomb panel having polygonal cells such that the honeycomb panels of the large-diameter disks and of the small-diameter disks are arranged to face each other and each polygonal cell communicates with more than one opposing polygonal cells. The fluid containing refrigerant and refrigerator oil is circulated in the heat pump system with a pressure of 0.2 to 10 MPa.

### TECHNICAL FIELD

The present invention relates to a liquefaction promoting apparatus for promoting fluid liquefaction by stirring the fluid which is disposed on a pipeline of a heat pump system, and more specifically to such an apparatus equipped with a flow mixer compressing the fluid through its slits, orifices, etc. or with rotary disks disposed along its axis.

### BACKGROUND ART

Heat pump systems using heat pump cycles, such as in refrigeration circle systems or air-conditioning systems, tend to have long pipelines and have various installation conditions. A heat pump system mainly consists of a compressor, a condenser, an expander and an evaporator. These devices are connected by way of a pipeline in which refrigerant is circulated. The refrigerant contains refrigerator oil. The compressor has a refrigerator oil reservoir. The refrigerator oil is mixed with or dissolved in the refrigerant and discharged from the compressor so as to be circulated through the heat pump cycle.

Conventionally used were refrigerants made of specified CFCs (ChloroFluoroCarbons) which are compatible with refrigerator oil but have been replaced with CFC alternatives due to the ozone layer depletion problem. The CFC alternatives have less compatibility with refrigerator oil than specified CFCs. This leads to a problem that the refrigerator oil discharged from the compressor is separated from the refrigerant and retained in the condenser or part of the pipelines so as to cause shortage of the refrigerator oil in the compressor.

There are other problems with refrigerator oil such as below. Refrigerant having less compatibility with refrigerator oil has less fluidity. Refrigerator oil retained in the condenser or the pipeline blocks the flow of the refrigerant and hinders heat exchange in the condenser and the evaporator. This lowers the heat exchange efficiency of the heat pump. In order to improve the compatibility of refrigerant and refrigerator oil, various additives such as chemical synthetic oils have been employed, but it does not provide sufficient solution. Also proposed are stirring means for uniformly mixing the refrigerator oil and the refrigerant.

Patent Document 1 discloses stirring device for stirring and mixing refrigerator oil and refrigerant in a compressor for the purpose of preventing separation thereof.

There is another problem with refrigerant. Gaseous refrigerant is still existent after the liquefaction process in the condenser and it circulates with the liquefied refrigerant. As the gaseous refrigerant passes through the expander and reaches the evaporator, the refrigerant becomes gas-liquid two phase fluid at the entrance of the evaporator. Since the gaseous refrigerant does not contribute to the heat exchange in the evaporator, it lowers the heat exchange efficiency.

Patent Documents 2 and 3 disclose gas-liquid separators disposed on the downstream side of the expander. The gas-liquid separators separate the gas-liquid two phase refrigerant so as to forward only the liquid refrigerant to the evaporator and return the gaseous refrigerant to the compressor.

Patent Document 4 discloses, as another solution, a bubble removing device which removes bubbles form the refrigerant when being liquefied in the compressor so as to completely liquefy the refrigerant. The bubble removing device comprises a cylindrical member and is installed on the downstream side of the compressor (or outdoor unit). The cylindrical member generates a spiral flow of the refrigerant so as to remove bubbles from the refrigerant by stirring.

Patent Documents 5, 6 and 7 disclose stirring devices which are not directly related to heat pumps. These stirring devices each comprises a cylindrical casing accommodating multi-layered disks each having polygonal cells so as to stir (mix) high-pressure fluid passing therethrough. These devices do not have rotating member such as motors.

### PRIOR ART DOCUMENT

### Patent Document

Patent Document 1: Japanese Patent Laid- open No. 2008-163782.
Patent Document 2: Japanese Patent Laid- open No. H06-109345.
Patent Document 3: Japanese Patent Laid- open No. 2008-75894.
Patent Document 4: WO 2013/99972.
Patent Document 5: Japanese Patent Published No. S59-39173.
Patent Document 6: Japanese Patent Laid-open No. H11-9980.
Patent Document 7: Japanese Patent Laid-open No. H11-114396.

### DISCLOSURE OF THE INVENTION

### Problems to be Solved by the Invention

The above-mentioned first problem of incompatibility of refrigerant and refrigerator oil cannot be solved only by employing a stirring means inside a compressor such as disclosed in Patent Document 1 since there will still be refrigerator oil retained in pipelines and other members.

Moreover, in a compressor having low temperature, refrigerator oil droplets tend to get fused so as to envelope liquefied refrigerant. Such refrigerant enveloped in refrigerator oil does not contribute to the heat exchange. This is likely to occur when the outdoor temperature is low.

The above-mentioned second problem of gaseous refrigerant remaining after liquefaction of refrigerant in the condenser can be solved, to an extent, by employing gas-liquid separators such as disclosed in Patent Documents 2 and 3 when in cooling operation, but not when in heating operation. Furthermore, since the disclosed gas-liquid separators are incorporated in the system, they are not versatile enough to be adapted to other existing systems. In order to improve the heat exchange efficiency of existing heat pump systems, it will take a stirring means which is easily adaptable thereto.

As embodiments of heat pump systems, there are provided various kinds of refrigerators and air-conditioners. There are needed to be stirring devices having versatility to be adapted to existing heat pump system.

On the other hand, stirring devices generating a spiral flow of the refrigerant such as disclosed in Patent Document 4 do not have enough stirring performance, since they cannot effectively remove from refrigerant bubbles which have passed thorough condensers retaining temperature higher than its condensing temperature.

The present inventors have confirmed by experiment that the device disclosed in Patent Document 4 generates spiral flow in a substantially horizontal plane does not provide stirring performance enough to lower the temperature of gaseous refrigerant beneath its condensing temperature and liquefy it.

In consideration of the above-mentioned problems, it is an object of the present invention to provide a fluid stirring and liquefaction promoting apparatus which enables dissolution of refrigerator oil into or uniform mixture of refrigerator oil with refrigerant by efficiently stirring fluid circulating in heat pump systems, and thereby improving the heat exchange efficiency of heat pump systems and reducing the energy consumption.

### Means for Solving the Problems

As a solution to the above- mentioned problems, the present invention has been accomplished, the details of which are described bellow.

As the present inventors have tested various stirring (or mixing) devices, those as disclosed in Patent Documents 5, 6 and 7 are found to be suitably adapted to a heat pump system to be disposed on one of its pipelines as a fluid stirring and liquefaction promoting apparatus.

According to the present invention, there is provided a static type liquefaction promoting apparatus to be disposed on a pipeline of a heat pump system for the purpose of stirring and uniformly mixing the fluid containing refrigerant and refrigerator oil circulating therein comprising:

a cylindrical casing having an inlet and an outlet on its axial ends;

one or more channelizing units each composed of a pair of large-diameter disks on its outer side and a pair of small-diameter disks on its inner side disposed in axial alignment inside said cylindrical casing,

said large-diameter disks each having a diameter consistent with the inner diameter of said cylindrical casing, being formed on its center with a flow hole and being formed on its inner surface with a honeycomb panel having polygonal cells,

said small-diameter disks being formed on its outer surface with a honeycomb panel having polygonal cells,

the honeycomb panels of said large-diameter disks and of said small-diameter disks being arranged to face each other such that each polygonal cell communicates with more than one opposing polygonal cells,

the flow holes of the two large-diameter disks disposed nearest to the inlet and the outlet of said cylindrical casing being communicated with the inlet and the outlet; wherein

the fluid containing refrigerant and refrigerator oil is circulated in the heat pump system with a pressure of 0.2 to 10 MPa.

The static type liquefaction promoting apparatus is characterized in that the inlet and outlet of said cylindrical casing are mutually alternated as the heat pump system alters between cooling operation and heating operation.

The static type liquefaction promoting apparatus is characterized in that it further comprises a heat radiation sink surrounding said cylindrical casing so as to conduct heat away therefrom.

According to the present invention, there is provided a rotating type liquefaction promoting apparatus to be disposed on a pipeline of a heat pump system for the purpose of stirring and uniformly mixing the fluid containing refrigerant and refrigerator oil circulating therein comprising:

a stirring sink for stirring the fluid having an inlet and an outlet on its ends;

a rotary stirring unit fixed on a shaft connected to a rotary driving source disposed in said stirring sink,

said rotary stirring unit being composed of an upper disk formed on its inner surface with a honeycomb panel having polygonal cells and a lower disk formed on its center with a flow hole and formed on its inner surface with a honeycomb panel having polygonal cells,

the honeycomb panels of said upper disk and of said lower disk being arranged to face each other such that each polygonal cell communicates with more than one opposing polygonal cells; wherein

the fluid containing refrigerant and refrigerator oil is circulated in the heat pump system with a pressure of 0.2 to 10 MPa.

The rotating type liquefaction promoting apparatus is characterized in that the inlet and outlet of said cylindrical casing are mutually alternated as the heat pump system alters between cooling operation and heating operation.

The rotating type liquefaction promoting is characterized in that it further comprises a heat radiation sink surrounding said cylindrical casing so as to conduct heat away therefrom.

The static type liquefaction promoting apparatus is characterized in that said cylindrical casing further comprises therein a spring member having a diameter smaller than the inner diameter of said cylindrical casing and being in a vibrable state.

The static type liquefaction promoting apparatus is characterized in that it comprises a heat radiation sink surrounding said cylindrical casing so as to conduct heat away therefrom.

The static type liquefaction promoting apparatus is characterized in that said heat radiation sink further comprises therein a spring member having a diameter smaller than the inner diameter of said heat radiation sink and being in a vibrable state.

The rotating type liquefaction promoting apparatus is characterized in that said stirring sink further comprises therein a spring member having a diameter smaller than the inner diameter of said stirring sink and being in a vibrable state.

The rotating type liquefaction promoting apparatus is characterized in that it further comprises a heat radiation sink surrounding said stirring sink so as to conduct heat away therefrom.

The rotating type liquefaction promoting apparatus is characterized in that said stirring sink further comprises therein a spring member having a diameter smaller than the inner diameter of said stirring sink and being in a vibrable state.

### Effects of the Invention

As described in the above, the present invention provides a fluid stirring and liquefaction promoting apparatus which enables uniform mixture of refrigerator oil with refrigerant in heat pump systems, and thereby improving the heat exchange efficiency of heat pump systems and reducing the energy consumption.

### BRIEF DESCRIPTION OF THE DRAWINGS

FIG. 1 is a view showing an example of a static type liquefaction promoting apparatus applied to a heat pump system. FIG. 1(a) shows the flow of fluid in cooling operation. FIG. 1(b) shows the flow of fluid in heating operation.

FIG. 2 is a view showing configuration of the honeycomb panels having polygonal cells. FIG. 2(a) is a plain view and FIG. 2(b) is an A-A cross section view.

FIG. 3 is a view showing various forms of honeycomb panels having polygonal cells. FIG. 3(a) shows one having octagonal cells. FIG. 3(b) shows one having hexagonal cells. FIG. 3(c) shows one having triangular cells. FIG. 3(d) shows one having square cells.

FIG. 4 is partial enlarged view of the channelizing unit consisting of the large-diameter disks, the small-diameter disks and the honeycomb panels.

FIG. 5 is a perspective view of the small-diameter disk.

FIG. 6 is a view showing an example of a static type liquefaction promoting apparatus according to the present invention which further comprises a heat radiation sink. FIG. 6(a) shows the flow of fluid in cooling operation. FIG. 6(b) shows the flow of fluid in heating operation.

FIG. 7 is a view showing an example of a rotating type liquefaction promoting apparatus according to the present invention. FIG. 7(a) shows the flow of fluid in cooling operation. FIG. 7(b) shows the flow of fluid in heating operation.

FIG. 8 shows the configuration of the rotary stirring unit composed of two disks.

FIG. 9 is a cross-sectional view showing the detailed configuration of the rotary stirring unit and the flow of the fluid therein.

FIG. 10 is a view showing various forms of honeycomb panels having polygonal cells. FIG. 10(a) shows one having triangular cells. FIG. 10(b) shows one having square cells. FIG. 10(c) shows one having octagonal cells. FIG. 10(d) shows one having hexagonal cells.

FIG. 11 is a view showing an example of a rotating type liquefaction promoting apparatus comprising a heat radiation sink according to the present invention. FIG. 11(a) shows the flow of fluid in cooling operation. FIG. 11(b) shows the flow of fluid in heating operation.

FIG. 12 is a cross-sectional view showing the detailed configuration of the rotary stirring units and the flow of the fluid therein.

FIG. 13 is a cross-sectional view showing a static type liquefaction promoting apparatus comprising a spring member in place of the channelizing units.

FIG. 14 is a cross-sectional view showing a static type liquefaction promoting apparatus comprising a spring member in addition to channelizing units.

FIG. 15 is a cross-sectional view showing a static type liquefaction promoting apparatus comprising a heat radiation sink in addition to a spring member and channelizing units.

FIG. 16 a cross-sectional view showing a static type liquefaction promoting apparatus comprising a heat radiation sink having a spring member and channelizing units.

FIG. 17 is a cross-sectional view showing a rotating type liquefaction promoting apparatus comprising a stirring sink having a spring member.

FIG. 18 is a cross-sectional view showing a rotating type liquefaction promoting apparatus comprising a stirring sink having a spring member and a heat radiation sink.

FIG. 19 Fig. is a cross-sectional view showing a rotating type liquefaction promoting apparatus comprising a stirring sink and a heat radiation sink having a spring member.

### BEST MODE FOR CARRYING OUT THE INVENTION

Described hereinafter with reference to the attached drawings are detailed embodiments of the device according to the present invention. In the figures, like reference numerals refer to like members which have similar basic composition and operation.

### First Embodiment

### <Configuration>

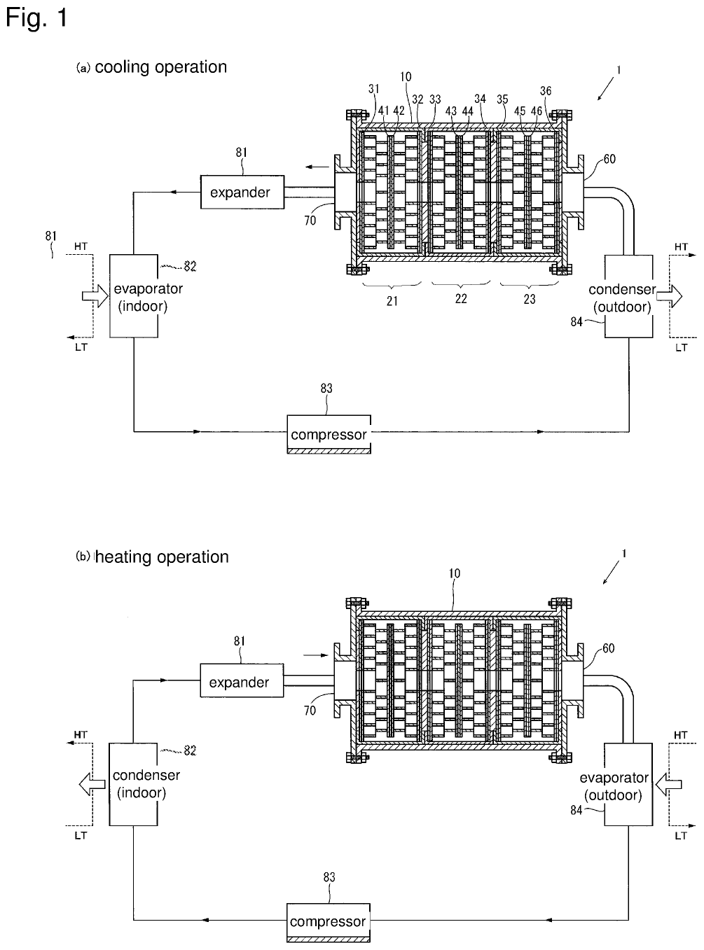

The first embodiment of the present invention is shown in FIGS. 1 through 5. FIG. 1 is a view showing an example of a static type liquefaction promoting apparatus 1 adapted to a heat pump system. The heat pump system may be an air-conditioner, a freezer, a refrigerator, a boiler, a freezing warehouse, a chiller and the like. It is not limited to a heat pump system run by electricity but may also be that by other types of power source such as a gas turbine. The static type liquefaction promoting apparatus can be adapted either to a yet-to-be-made heat pump system or to an existing heat pump system.

A heat pump system takes heat from a low temperature object and gives heat to a high temperature object for the purpose of cooling the low temperature object and/or warming the high temperature object. An air-conditioner switching between cooling operation and heating operation is also a heat pump system.

The term “fluid” used herein refers to that circulated through a heat pump cycle. It includes refrigerant and refrigerator oil. It can be either in a liquid, gas or gas-liquid mixed state in a heat pump cycle.

FIG. 1 shows a cross-sectional schematic view of a heat pump cycle adapted to an air-conditioner. FIG. 1(a) shows the flow of fluid in cooling operation. FIG. 1(b) shows the flow of fluid in heating operation.

The heat pump cycle in its cooling operation consists of a compressor 83, a condenser (outdoor unit) 84, an expander 81 and an evaporator (indoor unit) 82. The heat pump cycle in its heating operation consists of a compressor 83, a condenser (indoor unit) 82, an expander 81 and an evaporator (outdoor unit) 84. These components together with pipelines form an enclosed conduit in which fluid circulates. The arrows in FIG. 1(a) and FIG. 1(b) indicate the flow direction of the fluid. The void arrows indicate transfer of heat from and into the condenser and the evaporator. The broken arrows indicate transfer of heat between the outdoor and the indoor. “LH” means low temperature and “HT” means high temperature.

In the heat pump cycle in its cooling operation shown in FIG. 1(a), the compressor 83 has a sealed chamber with a refrigerator oil reservoir. The compressor 83 compresses gaseous refrigerant to have a high pressure and high temperature, which is mixed with the refrigerator oil and discharged to the condenser (outdoor unit) 84. In cooling operation, the condenser (outdoor unit) 84 conducts heat exchange by having the incoming high-temperature high-pressure gaseous fluid to dissipate heat to the outside and to be cooled and liquefied. The liquefied fluid is desirably a uniform mixture or solution of refrigerant and refrigerator oil.

Nevertheless, while refrigerant is liquefied in the condenser (outdoor unit) 84, there remains refrigerator oil which have not been mixed with or dissolved in the refrigerant or which have been fused to form oil phases enveloping liquefied refrigerant. There also remains refrigerator oil in the form of high-pressure gas even after passing the condenser (outdoor unit) 84. Thus, the liquefied fluid discharged from the condenser (outdoor unit) 84 possibly contains unmixed refrigerator oil, refrigerant enveloped in the oil phases of the refrigerator oil and/or gaseous refrigerant.

As shown in FIG. 1(a), the liquefaction promoting apparatus 1 in its cooling operation is disposed between the condenser (outdoor unit) 84 and the expander 81. The inlet 60 of the liquefaction promoting apparatus 1 is communicated with the outlet of the condenser (outdoor unit) 84 while the outlet 70 is communicated with the inlet of the expander 81. The fluid discharged from the condenser 84 is effectively sheared and mixed in the liquefaction promoting apparatus 1. Thus, the refrigerator oil having been unmixed gets uniformly mixed with the liquefied refrigerant, refrigerant having been enveloped in the oil phases of the refrigerator oil gets released and the residual gaseous refrigerant gets liquefied. The fluid flows from the liquefaction promoting apparatus 1 to the expander 81.

The expander 81 has an expansion valve or a capillary tube. The liquid fluid with low temperature and low pressure passes through small tubes or pores to have further lower temperature and lower pressure and released to the evaporator (indoor unit) 82. The low-temperature low-pressure liquid fluid absorbs heat from the outside so as to evaporate into a high-temperature gaseous fluid. This causes the indoor air to be cooled. The gaseous fluid flows into the compressor 83.

In the heat pump cycle in its heating operation shown in FIG. 1(b), the fluid flows in the adverse direction. The heat pump system has a switching valve (not shown) for switching the flow direction of the fluid. When in heating operation, the compressor 83 discharges high-temperature high-pressure gaseous fluid, which flows into the condenser (indoor unit) 82. The incoming high-temperature high-pressure gaseous fluid dissipates heat to the outside and gets and liquefied. This causes the indoor air to be warmed.

Similar to the case in the above described cooling operation shown in FIG. 1(a), the liquefied fluid discharged from the condenser (indoor unit) 82 possibly contains unmixed refrigerator oil, refrigerant enveloped in the oil phases of the refrigerator oil and/or gaseous refrigerant. In heating operation, the liquefied fluid discharged from the condenser (indoor unit) 82 flows into the expander 81, where it is expanded to have a low pressure and low temperature. The fluid having passed through the expander 81 still possibly contains unmixed refrigerator oil, refrigerant enveloped in the oil phases of the refrigerator oil and/or gaseous refrigerant.

As shown in FIG. 1(b), the liquefaction promoting apparatus 1 in its heating operation is disposed between the expander 81 and the evaporator (outdoor unit) 84. The inlet 70 of the liquefaction promoting apparatus 1 is communicated with the outlet of the expander 81 while the outlet 60 is communicated with the evaporator (outdoor unit) 84. The fluid discharged from the expander 81 is effectively sheared and mixed in the liquefaction promoting apparatus 1. Thus, the refrigerator oil having been unmixed gets uniformly mixed with the liquefied refrigerant, refrigerant having been enveloped in the oil phases of the refrigerator oil gets released and the residual gaseous refrigerant gets liquefied. The fluid flows from the liquefaction promoting apparatus 1 to the evaporator (outdoor unit) 84.

In heating operation, the evaporator (outdoor unit) 84 conducts heat exchange by having the incoming low-temperature low-pressure liquid fluid to absorb heat from the outside and to be heated and vaporized. The vaporized fluid flows into the compressor 83.

As shown in FIG. 1(a) and FIG. 1(b), the liquefaction promoting apparatus 1 according to the present invention is inserted on a pipeline of a heat pump system. Since such a pipeline consists of several tubular members, the liquefaction promoting apparatus 1 can easily be adapted to a heat pump system by replacing one of the tubular members thereof. It may be installed on an outdoor part of the pipeline.

Described in the above is an embodiment of the liquefaction promoting apparatus 1 adapted to a basic-type heat pump system according to the present invention. The liquefaction promoting apparatus 1 can also be adapted to different types of heat pump system equipped with various additional components. It can be adapted to, for example, a heat pump system equipped with a gas-liquid separator. It can also be adapted to a heat pump system having an ejector and a gas-liquid separator in place of an expander.

The liquefaction promoting apparatus 1 shown in FIG. 1(a) is a “static type” apparatus, which means it has unrotatable disks which are fixed to its cylindrical casing 10. The cylindrical casing 10 accommodates large-diameter disks 31, 32, 33, 34, 35 and 36, which are fixed and unrotatable. The large-diameter disks are each formed with a honeycomb panel having polygonal cells. The cylindrical casing 10 has elastic members disposed between its inner wall and the large-diameter disks so as not to pass the fluid therethrhough. The large-diameter disks 31, 32, 33, 34, 35 and 36 are each formed with a flow hole so as to pass the fluid therethrhough.

The cylindrical casing 10 also accommodates small-diameter disks 41, 42, 43, 44, 45 and 46. The small-diameter disks are each formed with a honeycomb panel having polygonal cells. Although small-diameter disks 41, 42, 43, 44, 45 and 46 do not have any flow hole, they are spaced apart from the inner wall of the cylindrical casing 10, allowing the fluid to pass therethrhough.

In the cylindrical casing 10, the large-diameter disks and the small-diameter disks are assembled to compose axially-aligned channelizing units 21, 22 and 23. The channelizing unit 21 is composed of the large-diameter disk 31, the mall-diameter disks 41 and 42 and the large-diameter disk 32 in this order. The other channelizing units are composed likewise. As the fluid flows from the inlet 60 to the outlet 70, it passes thorough three channelizing units 23, 22 and 21 and get effectively sheared and mixed in each of the channelizing units.

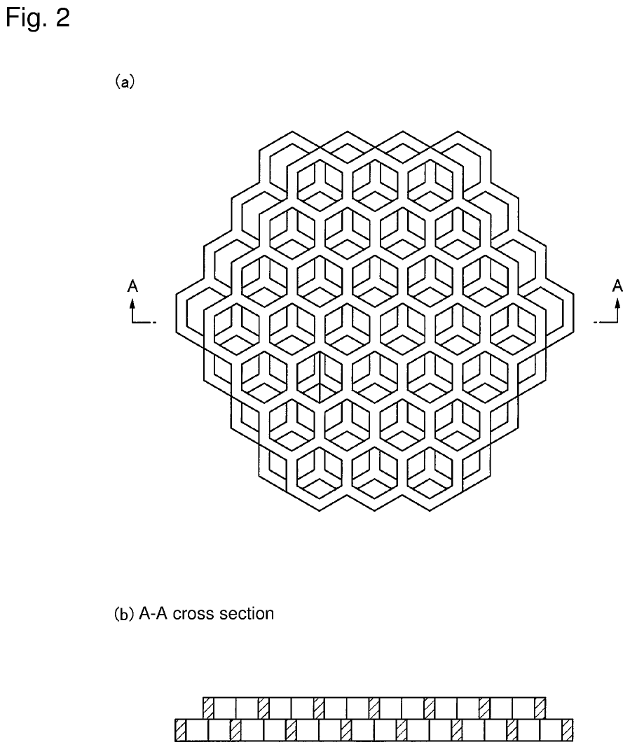

FIG. 2 is a view showing configuration of the honeycomb panels of the large-diameter disks and the small-diameter disks. FIG. 2(a) is a plain view and FIG. 2(b) is an A-A cross section view. As illustrated, the honeycomb panels have the hexagonal cells tightly arranged without clearance. The adjacent honeycomb panels are arranged such that the hexagonal cells of the two honeycomb panels do not overlap each other. This causes the pathway of the fluid to be complicated and thus allows the fluid to be effectively sheared.

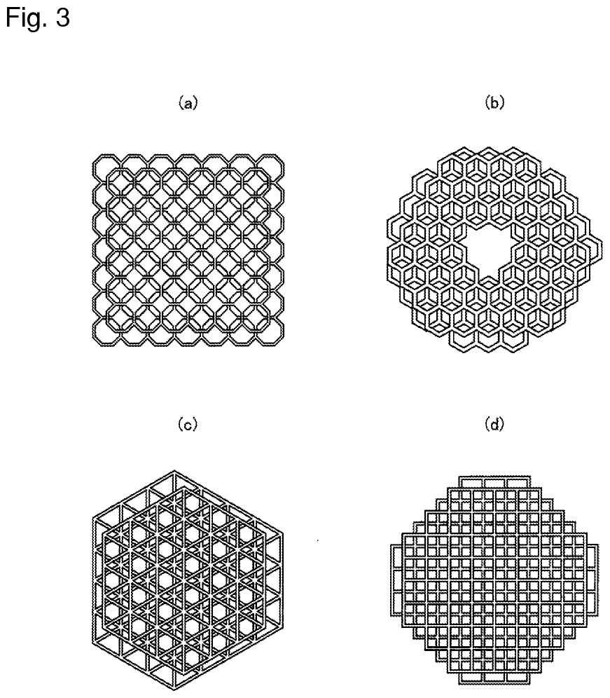

FIG. 3 is a view showing various forms of honeycomb panels having polygonal cells. FIG. 3(a) shows one having octagonal cells. FIG. 3(b) shows one having hexagonal cells. FIG. 3(c) shows one having triangular cells. FIG. 3(d) shows one having square cells. The “honeycomb” panel described herein is not limited to the one having hexagonal cells but also includes one having any kinds of regular polygonal cells which can be tightly arranged without clearance. The adjacent two honeycomb panels of the large-diameter disk and of the small-diameter disk are arranged to face each other such that each polygonal cell communicates with more than one opposing polygonal cells. This causes the pathway of the fluid to be complicated and thus allows the fluid to be effectively sheared.

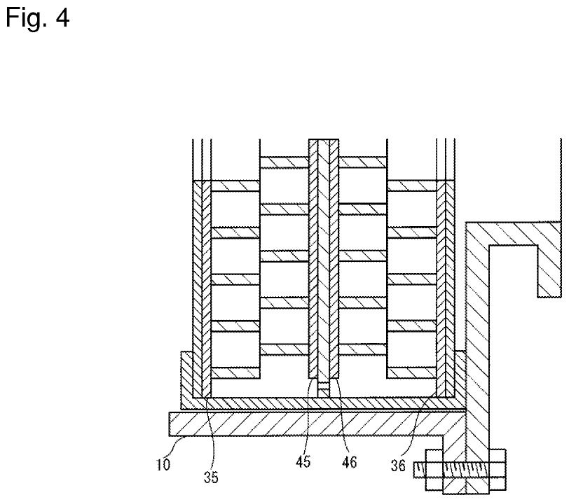

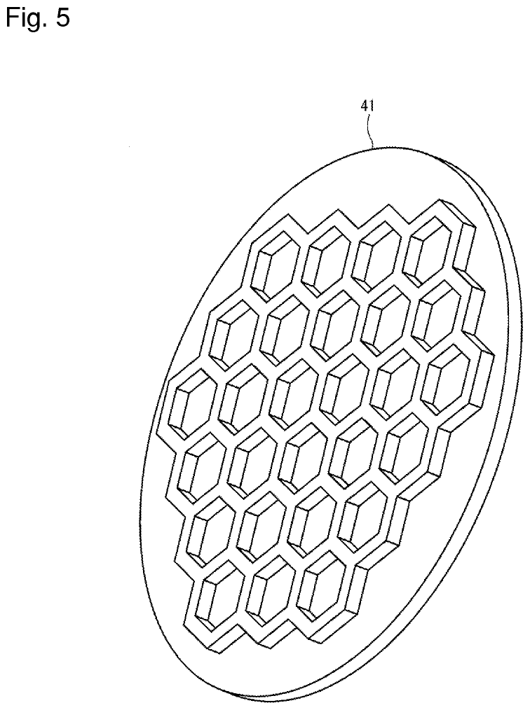

FIG. 4 is partial enlarged view of the channelizing unit 23 consisting of the large-diameter disks 35 and 36, and the small-diameter disks 45 and 46 and the honeycomb panels. As illustrated, a flow hole is formed near the peripheral side of the small-diameter disks 45 and 46 communicating therebetween.

FIG. 5 is a perspective view of the small-diameter disk 41. The small-diameter disk 41 is formed with the honeycomb panel having hexagonal cells.

### <Operation>

Fluid containing refrigerant and refrigerator oil is flown through the liquefaction promoting apparatus 1 under a pressure of 0.2 to 10 MPa so as to be effectively sheared and uniformly mixed. This contributes to the improvement of heat exchange efficiency of the CFC alternatives.

Although FIG. 1 shows the liquefaction promoting apparatus 1 horizontally set, it maybe set vertically.

### Second Embodiment

### <Use of Heat Radiation Sink>

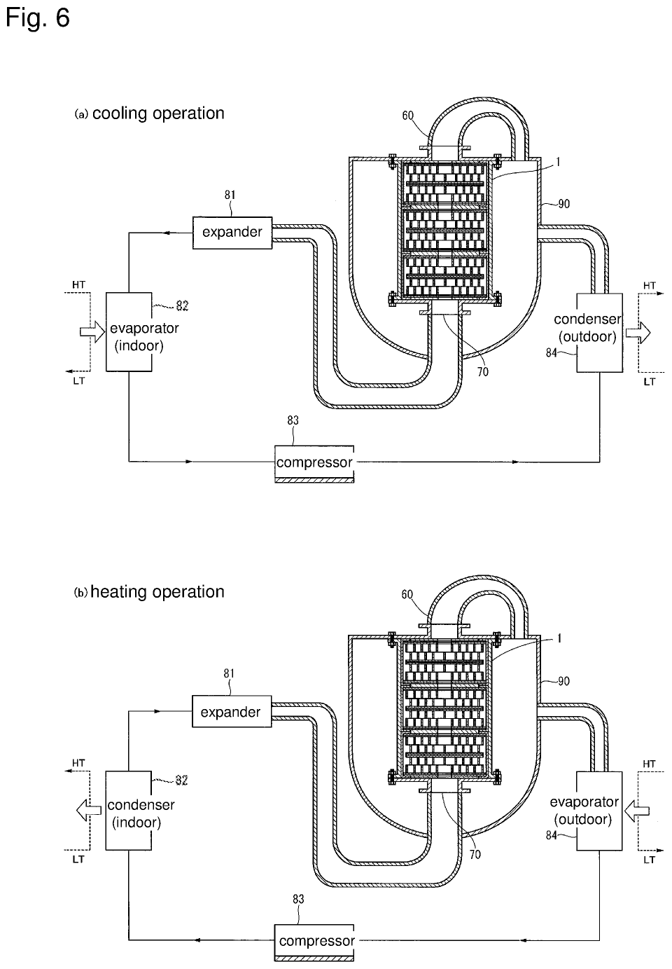

FIG. 6 is a view showing an example of a static type liquefaction promoting apparatus 1 according to the present invention which further comprises a heat radiation sink. FIG. 6(a) shows the flow of fluid in cooling operation. FIG. 6(b) shows the flow of fluid in heating operation.

There is provided a heat radiation sink 90 hermetically accommodating the cylindrical casing 10. In cooling operation as shown in FIG. 6(a), the fluid flown from the condenser (outdoor unit) 84 is once stored in the heat radiation sink 90 so as to take heat away from the cylindrical casing 10. The fluid is then introduced into the static type liquefaction promoting apparatus 1 through the inlet 60 and let out through the outlet 70. In heating operation as shown in FIG. 6(b), the fluid let out of the outlet 60 is once stored in the heat radiation sink 90 so as to take heat away from the cylindrical casing 10.

The heat radiation sink 90 prevents the cylindrical casing 10 from being overheated, and thus contributes to reduction of power consumption.

### Third Embodiment

### <Rotating Type>

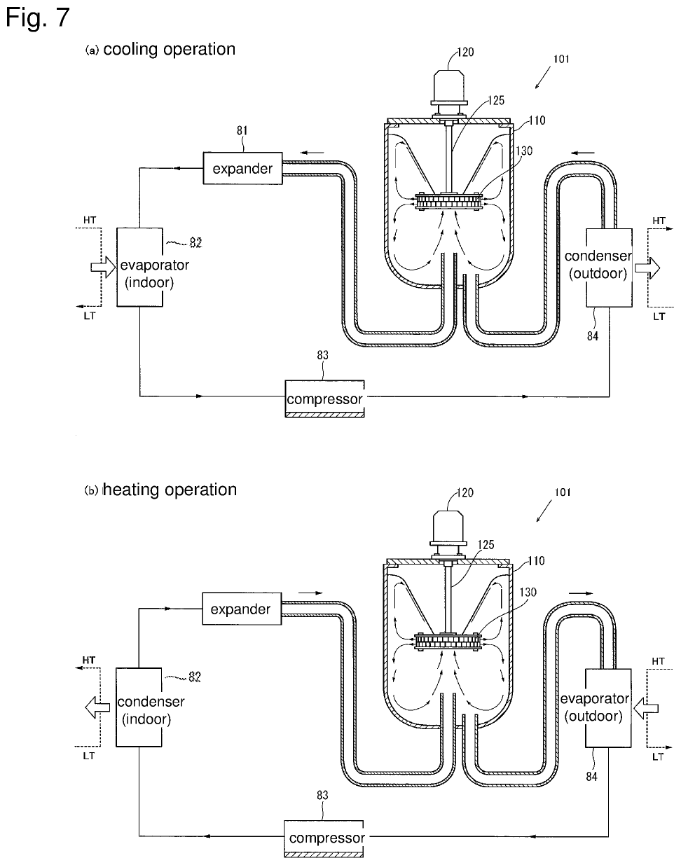

FIG. 7 is a view showing an example of a rotating type liquefaction promoting apparatus 101 according to the present invention. FIG. 7(a) shows the flow of fluid in cooling operation. FIG. 7(b) shows the flow of fluid in heating operation.

The rotating type liquefaction promoting apparatus 101 has a stirring sink 110 and a rotary stirring unit 130 fixed on a shaft 125 connected to a rotary driving source 120 (such as a motor). The rotary stirring unit 130 is rotated so as to uniformly mix the fluid in the stirring sink 110.

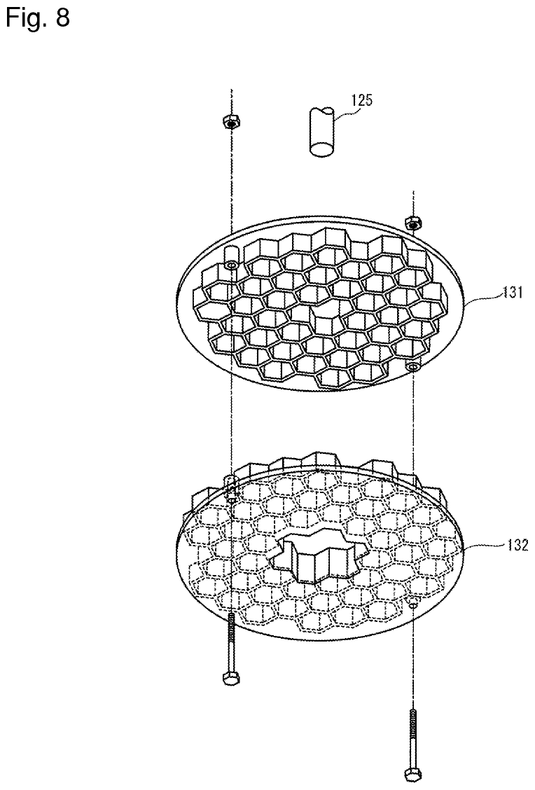

FIG. 8 shows the configuration of the rotary stirring unit 130 composed of two disks 131 and 132. The upper disk 131 and the lower disk 132 are each formed with a honeycomb panel having hexagonal cells are disposed such that the two honeycomb panels face each other. The two honeycomb panels are arranged such that the hexagonal cells of the two honeycomb panels do not overlap each other. The rotary stirring unit 130 is connected to the shaft 125. The upper disk 131 and the lower disk 132 each are formed with a flow hole so as to pass the fluid therethrough.

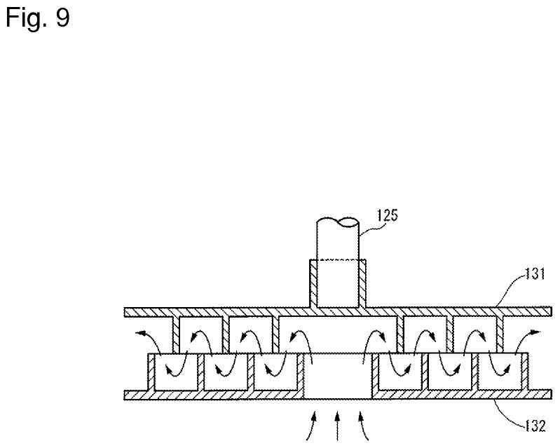

FIG. 9 is a cross-sectional view showing the detailed configuration of the rotary stirring unit 130 and the flow of the fluid therein. As illustrated, the fluid is introduced into the rotary stirring unit 130 mainly through its lower flow hole and flown to the peripheral side passing through the cells. This allows the fluid to be effectively sheared and uniformly mixed. The uniformly mixed fluid let out of the stirring sink 110 through its outlet.

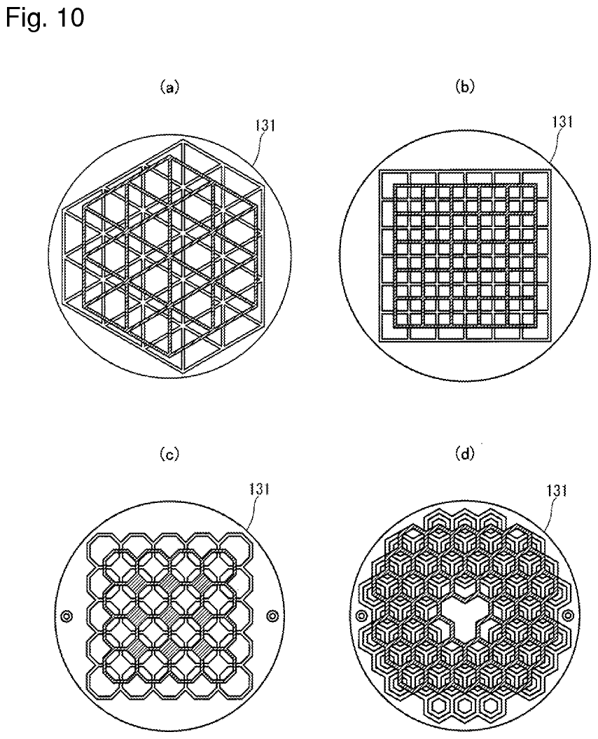

FIG. 10 is a view showing various forms of honeycomb panels having polygonal cells. FIG. 10(a) shows one having triangular cells. FIG. 10(b) shows one having square cells. FIG. 10(c) shows one having octagonal cells. FIG. 10(d) shows one having hexagonal cells.

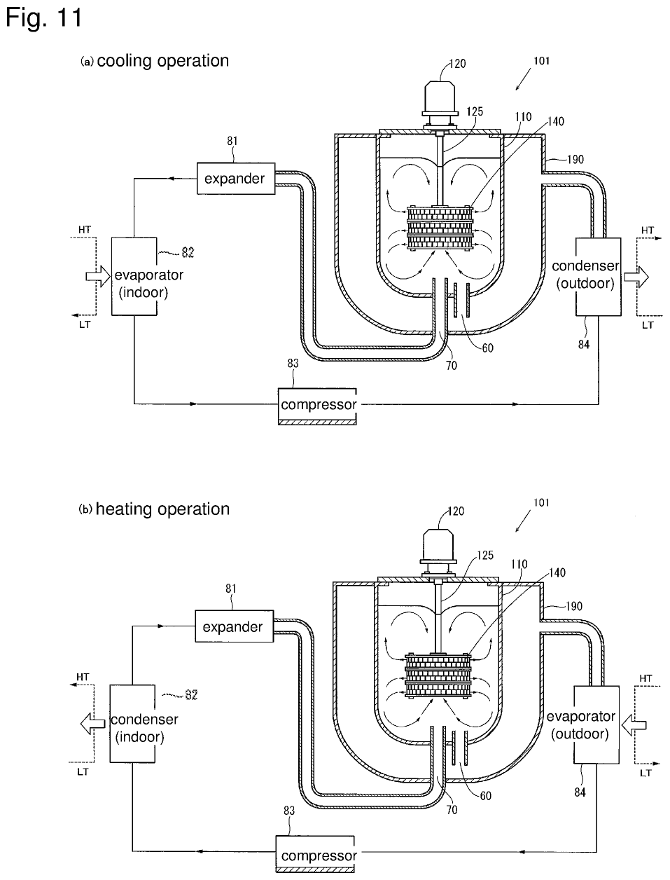

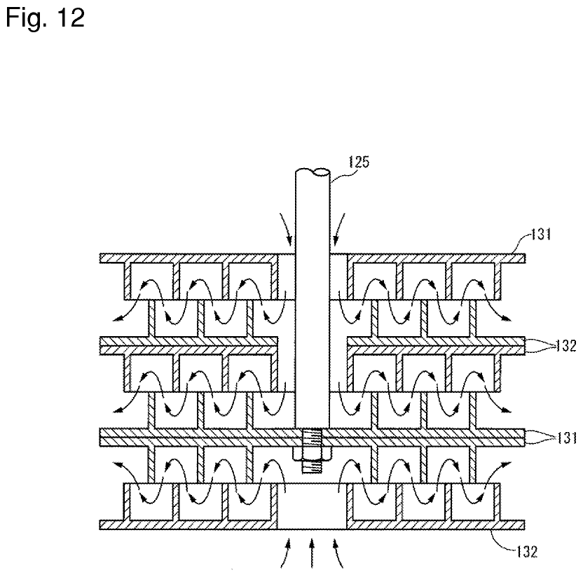

The rotating type liquefaction promoting apparatus 101 may have more than one rotary stirring units as described below with reference to FIGS. 11 and 12.

### Fourth Embodiment

### <Use of Heat Radiation Sink in Rotating Type>

FIG. 11 is a view showing an example of a rotating type liquefaction promoting apparatus 101 comprising a heat radiation sink 190 according to the present invention. FIG. 11(a) shows the flow of fluid in cooling operation. FIG. 11(b) shows the flow of fluid in heating operation. This apparatus is configured and operates in a similar way as the apparatus shown in FIG. 6.

FIG. 12 is a cross-sectional view showing the detailed configuration of the rotary stirring units 140 and the flow of the fluid therein. As illustrated, the fluid is introduced into the rotary stirring units through their upper and lower flow holes and flown to the peripheral side passing through the cells. This allows the fluid to be effectively sheared and uniformly mixed.

### Fifth Embodiment

### <Use of Spring Member>

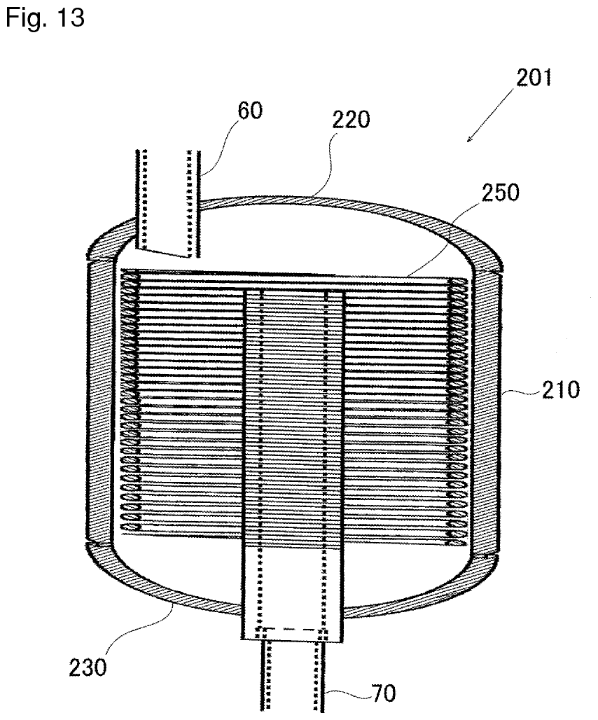

FIG. 13 is a cross-sectional view showing a static type liquefaction promoting apparatus 201 comprising a spring member in place of the channelizing units. As illustrated, the liquefaction promoting apparatus 201 does not have channelizing units but has a spring member 250 accommodated in a cylindrical casing 210. The spring member is a spirally wound spring having a diameter smaller than the inner diameter of the cylindrical casing 210. The spring member 250 is configured so as to be spaced apart from the inner wall of the cylindrical casing 210 (preferably by 0.1 to 5 mm). The space allows the spring member 250 to vibrate.

The cylindrical casing 210 has an upper casing 220 and a lower casing 230 and these members are assembled to form a hermetically sealed chamber. The chamber is capable of accommodating fluid with a pressure of up to 10 MPa. The upper casing 220 is formed with an inlet 60. The lower casing 230 is formed with an outlet 70. The inlet 60 and the outlet 70 are arranged so as not to align vertically in order to prevent the fluid flowing in through the inlet 60 from immediately flowing out through the outlet 70.

### <Operation>

As the fluid containing refrigerant and refrigerator oil with a pressure of 0.2 to 10 MPa passes through the liquefaction promoting apparatus 201, the spring member 250 is randomly vibrated horizontally and laterally so as to suppress fluctuation of the pressure of the fluid and level the pressure. The spring member 250 also allows the refrigerant and the refrigerator oil contained in the fluid to be effectively sheared and uniformly mixed. This contributes to the improvement of heat exchange efficiency of the CFC alternatives. The longer the fluid circulates the heat pump system, the more the heat exchange efficiency improves.

### Sixth Embodiment

### <Use of Spring Member in Static Type>

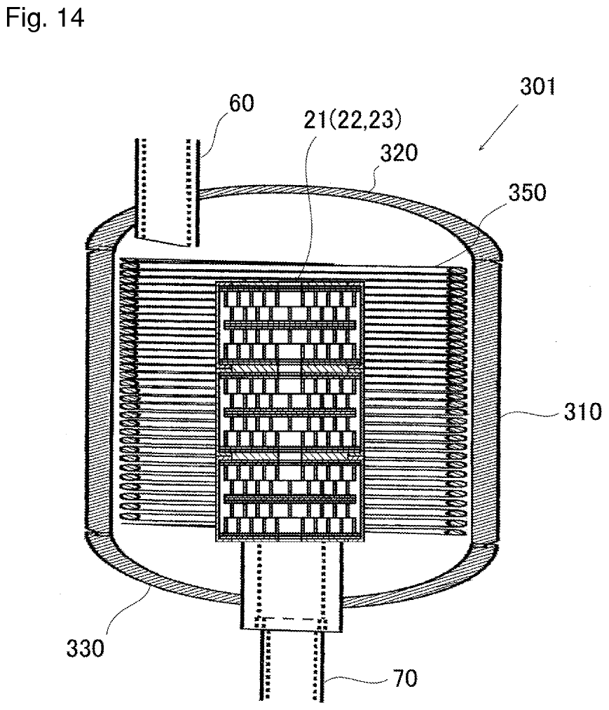

FIG. 14 is a cross-sectional view showing a static type liquefaction promoting apparatus 301 comprising a spring member in addition to channelizing units. As illustrated, the liquefaction promoting apparatus 301 comprises channelizing units 21, 22 and 23 each formed with a honeycomb panel having polygonal cells and a spring member 350. Similar to the liquefaction promoting apparatus 201, the spring member 350 is configured so as to be spaced apart from the inner wall of the cylindrical casing 310, which allows the spring member 350 to vibrate.

Also similar to the liquefaction promoting apparatus 201, the cylindrical casing 310 has an upper casing 220 and a lower casing 230 and these members are assembled to form a hermetically sealed chamber, which is capable of accommodating fluid with a pressure of up to 10 MPa. The upper casing 220 is formed with an inlet 60. The lower casing 230 is formed with an outlet 70. The inlet 60 and the outlet 70 are arranged so as not to align vertically in order to prevent the fluid flowing in through the inlet 60 from immediately flowing out through the outlet 70.

### <Operation>

The spring member 350 of the liquefaction promoting apparatus 301 allows the refrigerant and the refrigerator oil contained in the fluid to be effectively sheared and uniformly mixed in the same way as in the liquefaction promoting apparatus 201. The channelizing units 21, 22 and 23 also have shearing and stirring effect. Thus, the spring member 350 and the channelizing units 21, 22 and 23 in combination provide a multiple effect of shearing and stirring. This contributes to the improvement of heat exchange efficiency of the CFC alternatives. The longer the fluid circulates the heat pump system, the more the heat exchange efficiency improves.

### Seventh Embodiment

### <Use of Heat Radiation Sink and Spring Member in Static Type>

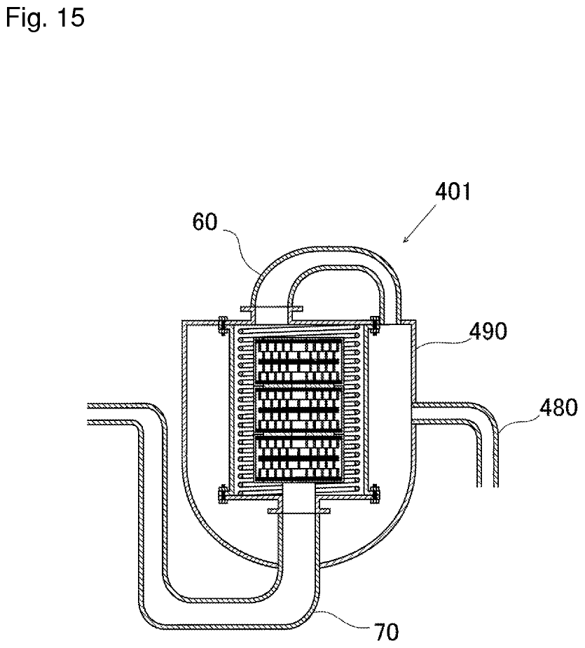

FIG. 15 is a cross-sectional view showing a static type liquefaction promoting apparatus 401 comprising a heat radiation sink in addition to a spring member and channelizing units. As illustrated, the liquefaction promoting apparatus 401 comprises channelizing units each formed with a honeycomb panel having polygonal cells, a spring member and a heat radiation sink 490, which is similar to the heat radiation sink 90 (shown in FIG. 6). This configuration enables it to suppress heat generation of the liquefaction promoting apparatus 401, thereby improving the heat exchange efficiency and reducing the energy consumption.

### Eighth Embodiment

<Use of Heat Radiation Sink having Spring Member in Static Type>

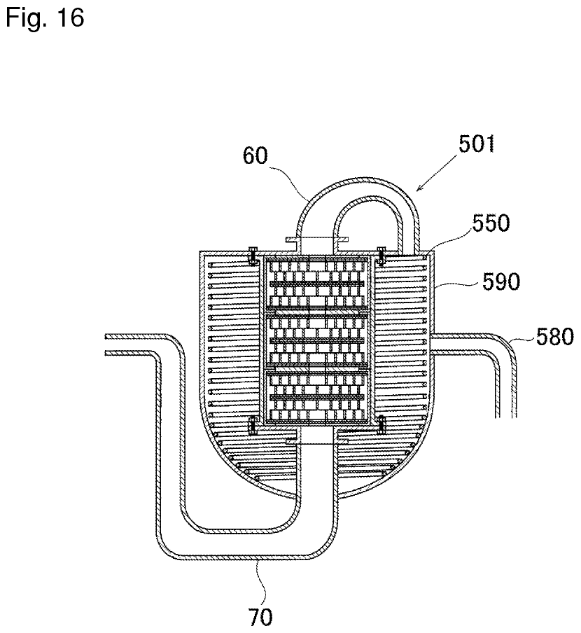

FIG. 16 a cross-sectional view showing a static type liquefaction promoting apparatus 501 comprising a heat radiation sink having a spring member 550 and channelizing units. The liquefaction promoting apparatus 501 is configured similarly to the apparatus shown in FIG. 6 but is different from it in that the heat radiation sink 590 accommodates a spring member 550. As illustrated, the spring member 550 is tapered to have smaller diameter downward. The spring member 550 can also be adapted to the apparatus shown in FIGS. 13, 14 and 15. The tapered shape enables it to generate complicated follow of the fluid and thus allows the fluid to be effectively sheared. The heat radiation sink 590 suppresses heat generation of the liquefaction promoting apparatus 501, thereby improving the heat exchange efficiency and reducing the energy consumption.

### Ninth Embodiment

### <Use of Spring Member in Rotating Type>

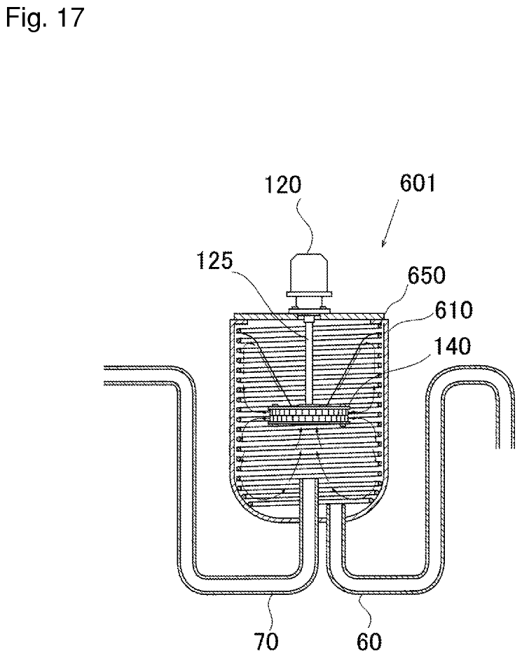

FIG. 17 is a cross-sectional view showing a rotating type liquefaction promoting apparatus 601 comprising a stirring sink having a spring member. As illustrated, the liquefaction promoting apparatus 601 comprises a stirring sink 610 accommodating a spring member 650, which is allowed to vibrate freely. The rotary stirring unit 140 driven by the rotary driving source 120 rotates at a high speed so as to effectively shear the fluid while the spring member 650 suppresses fluctuation of the pressure of the fluid. This configuration provides a multiple effect of shearing and stirring, thereby improving the heat exchange efficiency and reducing the energy consumption.

### Tenth Embodiment

### <Use of Spring Member in Stirring Sink and Heat Radiation Sink>

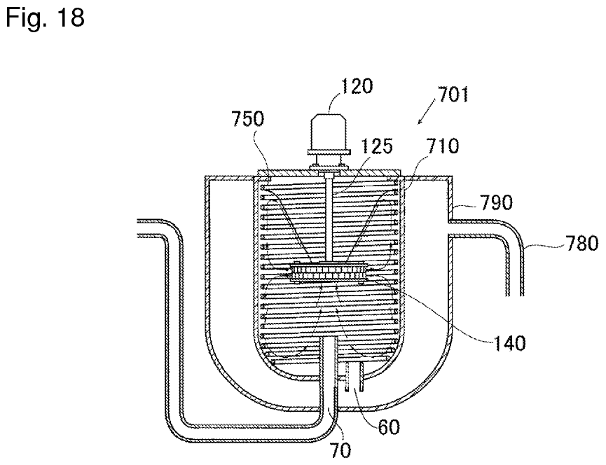

FIG. 18 is a cross-sectional view showing a rotating type liquefaction promoting apparatus 701 comprising a stirring sink having a spring member and a heat radiation sink 790. As illustrated, the liquefaction promoting apparatus 701 is configured similarly to the apparatus shown in FIG. 17 but is different from it in that it further comprises a heat radiation sink 790. The rotary stirring unit 140 driven by the rotary driving source 120 rotates at a high speed so as to effectively shear the fluid while the spring member 750 suppresses fluctuation of the pressure of the fluid. The heat radiation sink 790 suppresses heat generation of the liquefaction promoting apparatus 701. This configuration provides a multiple effect of shearing and stirring, thereby improving the heat exchange efficiency and reducing the energy consumption.

### Eleventh Embodiment

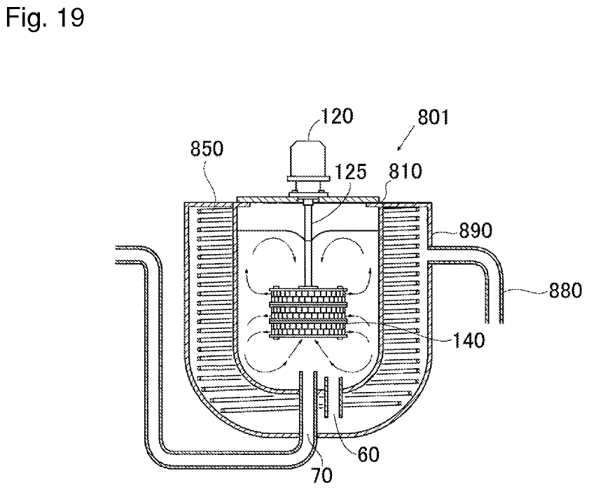

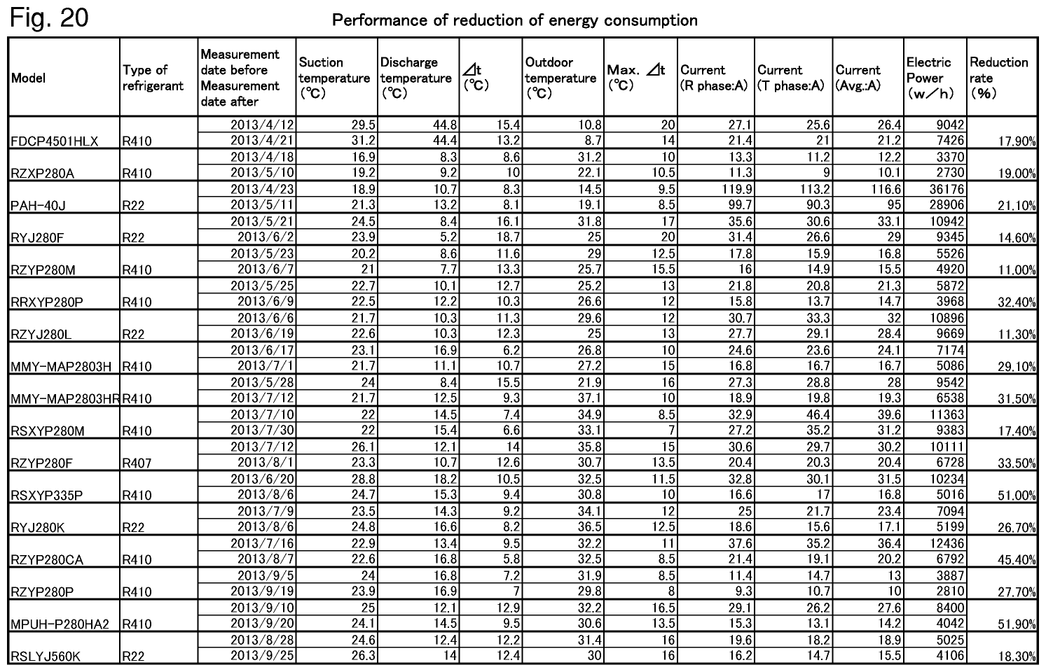

FIG. 19 Fig. is a cross-sectional view showing a rotating type liquefaction promoting apparatus 801 comprising a stirring sink 810 and a heat radiation sink 890 having a spring member 850. The rotary stirring unit 140 driven by the rotary driving source 120 rotates at a high speed so as to effectively shear the fluid while the spring member 850 suppresses fluctuation of the pressure of the fluid. The heat radiation sink 890 suppresses heat generation of the liquefaction promoting apparatus 801. This configuration provides a multiple effect of shearing and stirring, thereby improving the heat exchange efficiency and reducing the energy consumption.

### <Performance of Reduction of Energy Consumption>

FIG. 20 shows experimental results of energy consumption reduction in the existing heat pump systems to which the liquefaction promoting apparatus 301 according to the sixth embodiment was adapted to. In the figure, “Model” indicates the model numbers of heat pump systems. “Type of refrigerant” indicates the types of refrigerant such as TR410, R22, etc. “Measurement date before” indicates the dates of measurement before the liquefaction promoting apparatus 301 was adapted to the existing heat pump systems. “Measurement date after” indicates the dates of measurement after the liquefaction promoting apparatus 301 was adapted to the existing heat pump cycles. “Suction temperature” and “Discharge temperature” indicate temperatures at the suction ports and discharge ports of air conditioners. “Δt” indicates temperature difference of the suction temperature and the discharge temperature. “Outdoor temperature” indicates the outdoor temperature. “Max.Δt” indicates the maximum temperature difference measured. R-phase current, T-phase current and average current were measured. “Electric power” is measured in watt-hour. “Reduction rate” indicates the percentile ratio of electric power consumption after and before the liquefaction promoting apparatus 301 was adapted to the existing heat pump cycles.

As clearly shown in FIG. 20, the liquefaction promoting apparatus 301 according to the sixth embodiment which was adapted to the existing heat pump systems has contributed to reducing energy consumption in the heat pump systems by 11 to 51.9%.

The liquefaction promoting apparatus according to the present invention can be adapted to wide variety of heat pumps including those using electric energy and gas energy as long the heat pumps conduct heat exchange by circulating fluid containing refrigerant and refrigerator oil.

### REFERENCE SYMBOLS

1 static type liquefaction promoting apparatus
10 cylindrical casing
21, 22, 23 channelizing unit
31, 32, 33, 34, 35, 36 large-diameter disk
41, 42, 43, 44, 45, 46 small-diameter disk
60 inlet/outlet (in cooling/heating operation)
70 outlet/inlet (in cooling/heating operation)
81 expander
82 evaporator (indoor unit)
83 compressor
84 condenser (outdoor unit)
90 heat radiation sink
101 rotating type liquefaction promoting apparatus
110 stirring sink
120 rotary driving source
125 shaft
130, 140 rotary stirring unit
131 upper disk
132 lower disk
190 heat radiation sink
201 liquefaction promoting apparatus
210 cylindrical casing
220 upper casing
230 lower casing
250 spring member
301 static type liquefaction promoting apparatus
310 cylindrical casing
350 spring member
401 static type liquefaction promoting apparatus
480 pipeline of heat radiation sink
490 heat radiation sink
501 static type liquefaction promoting apparatus
550 spring member
580 pipeline of heat radiation sink
590 heat radiation sink
601 rotating type liquefaction promoting apparatus
610 stirring sink
650 spring member
701 rotating type liquefaction promoting apparatus
750 spring member
780 pipeline of heat radiation sink
790 heat radiation sink
801 rotating type liquefaction promoting apparatus
810 stirring sink
850 spring member
880 pipeline of heat radiation sink
890 heat radiation sink

1. A static type liquefaction promoting apparatus to be disposed on a pipeline of a heat pump system for the purpose of stirring and uniformly mixing the fluid containing refrigerant and refrigerator oil circulating therein comprising:
a cylindrical casing having an inlet and an outlet on its axial ends;
one or more channelizing units each composed of a pair of large-diameter disks on its outer side and a pair of small-diameter disks on its inner side disposed in axial alignment inside said cylindrical casing,
said large-diameter disks each having a diameter consistent with the inner diameter of said cylindrical casing, being formed on its center with a flow hole and being formed on its inner surface with a honeycomb panel having polygonal cells,
said small-diameter disks being formed on its outer surface with a honeycomb panel having polygonal cells,
the honeycomb panels of said large-diameter disks and of said small-diameter disks being arranged to face each other such that each polygonal cell communicates with more than one opposing polygonal cells,
the flow holes of the two large-diameter disks disposed nearest to the inlet and the outlet of said cylindrical casing being communicated with the inlet and the outlet; wherein
the fluid containing refrigerant and refrigerator oil is circulated in the heat pump system with a pressure of 0.2 to 10 MPa.

2. The static type liquefaction promoting apparatus as set forth in claim 1, wherein the inlet and outlet of said cylindrical casing are mutually alternated as the heat pump system alters between cooling operation and heating operation.

3. The static type liquefaction promoting apparatus as set forth in claim 2 further comprising a heat radiation sink surrounding said cylindrical casing which communicates with said inlet or outlet of said cylindrical casing and allows said fluid to pass therethrough, said fluid in said heat radiation sink in contact with the outer wall of said cylindrical casing conducting heat away therefrom.

4. A rotating type liquefaction promoting apparatus to be disposed on a pipeline of a heat pump system for the purpose of stirring and uniformly mixing the fluid containing refrigerant and refrigerator oil circulating therein comprising:
a stirring sink for stirring the fluid having an inlet and an outlet on its ends;
a rotary stirring unit fixed on a shaft connected to a rotary driving source disposed in said stirring sink,
said rotary stirring unit being composed of an upper disk formed on its inner surface with a honeycomb panel having polygonal cells and a lower disk formed on its center with a flow hole and formed on its inner surface with a honeycomb panel having polygonal cells,
the honeycomb panels of said upper disk and of said lower disk being arranged to face each other such that each polygonal cell communicates with more than one opposing polygonal cells; wherein
the fluid containing refrigerant and refrigerator oil is circulated in the heat pump system with a pressure of 0.2 to 10 MPa.

5. The rotating type liquefaction promoting apparatus as set forth in claim 4, wherein the inlet and outlet of said cylindrical casing are mutually alternated as the heat pump system alters between cooling operation and heating operation.

6. The rotating type liquefaction promoting apparatus as set forth in claim 5 further comprising a heat radiation sink surrounding said stirring sink which communicates with said inlet or outlet of said stirring sink and allows said fluid to pass therethrough, said fluid in said heat radiation sink in contact with the outer wall of said stirring sink conducting heat away therefrom.

7. The static type liquefaction promoting apparatus as set forth in claim 1, wherein said cylindrical casing further comprises therein a spring member having a diameter smaller than the inner diameter of said cylindrical casing and being in a vibrable state.

8. The static type liquefaction promoting apparatus as set forth in claim 7 further comprising a heat radiation sink surrounding said cylindrical casing which communicates with said inlet or outlet of said cylindrical casing and allows said fluid to pass therethrough, said fluid in said heat radiation sink in contact with the outer wall of said cylindrical casing conducting heat away therefrom.

9. The static type liquefaction promoting apparatus as set forth in claim 3, wherein said heat radiation sink further comprises therein a spring member having a diameter smaller than the inner diameter of said heat radiation sink and being in a vibrable state.

10. The rotating type liquefaction promoting apparatus as set forth in claim 4, wherein said stirring sink further comprises therein a spring member having a diameter smaller than the inner diameter of said stirring sink and being in a vibrable state.

11. The rotating type liquefaction promoting apparatus as set forth in claim 10 further comprising a heat radiation sink surrounding said stirring sink which communicates with said inlet or outlet of said stirring sink and allows said fluid to pass therethrough, said fluid in said heat radiation sink in contact with the outer wall of said stirring sink conducting heat away therefrom.

12. The rotating type liquefaction promoting apparatus as set forth in claim 6, wherein said stirring sink further comprises therein a spring member having a diameter smaller than the inner diameter of said stirring sink and being in a vibrable state.

13. The static type liquefaction promoting apparatus as set forth in claim 8, wherein said heat radiation sink further comprises therein a spring member having a diameter smaller than the inner diameter of said heat radiation sink and being in a vibrable state.

14. The rotating type liquefaction promoting apparatus as set forth in claim 11, wherein said stirring sink further comprises therein a spring member having a diameter smaller than the inner diameter of said stirring sink and being in a vibrable state.
